(19) United States
(12) Patent Application Publication
(10) Pub. No.: US 2007/0018578 A1
(43) Pub. Date: Jan. 25, 2007

(54) Plasma display panel

(76) Inventor: Kyoung-Doo Kang, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/489,531

(22) Filed: Jul. 20, 2006

(30) Foreign Application Priority Data
Jul. 22, 2005 (KR) 10-2005-0066678

(51) Int. Cl. H01J 17/49

(52) U.S. Cl. 313/582

(57) ABSTRACT

A plasma display panel including a first substrate, a second substrate opposite the first substrate, at least one discharge space defined between the first and second substrates, a first electrode structure disposed between the first and second substrates and extending in a first direction, a barrier rib structure disposed between the first and second substrates, the barrier rib structure surrounding the discharge space, a second electrode structure disposed between the first and second substrates, surrounding the discharge space, and extending in a second direction, the second direction crossing the first direction, and a third electrode structure disposed between the first and second substrates, surrounding the discharge space, and extending in the second direction.

### BACKGROUND OF THE INVENTION

1. Field of the Invention

The present invention relates to a plasma display panel. More particularly, the present invention relates to a plasma display panel that may enable an enlarged discharge space in a high-definition display and may exhibit enhanced luminance and luminous efficiency.

2. Description of the Related Art

Generally, a plasma display panel (PDP) produces an image by generating a plasma discharge in a discharge cell, which causes an emission of ultraviolet (UV) light, e.g., vacuum UV (VUV) light. The UV light impinges on and energizes a phosphor which emits visible light of a predetermined color upon relaxing to a low energy state. In a three electrode surface-discharge type PDP, the plasma discharge may be controlled using three electrodes, viz., an address electrode, a scan electrode and a sustain electrode. In operation, a scanning pulse may be applied to the scan electrode and an address pulse may be applied to the address electrode so that an address discharge is generated between the scan and address electrodes. That is, a discharge cell may be turned on or selected by the address-scan discharge. A sustain pulse may be alternately applied to the scan electrode and the sustain electrode of the selected discharge cell in order to generate a sustain discharge and maintain visible light emission from the discharge cell, i.e., display an image. The address, scan and sustain electrodes may be independently controlled.

The address electrode may be arranged on a rear substrate, and the sustain and scan electrodes may be arranged in parallel on a same surface of a front substrate, through which the visible image is displayed, so as to cross the address electrode. Barrier ribs may partition discharge cells between the front substrate and the rear substrate, where the barrier ribs are disposed between the rear substrate having the address electrode and the front substrate having the sustain and scan electrodes. A discharge cell may be positioned in a region where the address electrode crosses the sustain and scan electrodes, such that the electrodes can control discharge within the discharge cell. The discharge cell may be charged with a discharge gas.

Since the visible image is displayed through the front substrate, having the sustain and scan electrodes located to the front of the discharge cell may interfere with the emission of visible light. In particular, since visible light may be blocked by opaque scan and sustain electrodes, or only partially transmitted by transparent sustain and scan electrodes, the placement of the sustain and scan electrodes to the front of the discharge cell may effectively reduce the aperture ratio of the discharge cell. As a result, the PDP may exhibit low luminance and luminous efficiency. Moreover, when the PDP is used for a long time, charged particles in the discharge gas may generate ion sputtering in the phosphor through action of the electric field, such that a permanent after-image results.

The information provided above in the Background may not correspond to a particular plasma display panel. Rather, this information is set forth only for enhancing an understanding of the field of art.

### SUMMARY OF THE INVENTION

The present invention is therefore directed to a plasma display panel, which substantially overcomes one or more of the problems due to the limitations and disadvantages of the related art.

It is therefore a feature of an embodiment of the present invention to provide a plasma display panel including electrode structures that may surround a discharge space.

It is therefore another feature of an embodiment of the present invention to provide a plasma display panel including electrode structures that may include two portions disposed along opposite sides of the discharge space.

It is therefore yet another feature of an embodiment of the present invention to provide a plasma display panel including electrode structures that may be disposed along sidewalls of the discharge space.

It is therefore still another feature of an embodiment of the present invention to provide a plasma display panel including a layer that serves as an electrode layer and a barrier rib layer.

At least one of the above and other features and advantages of the present invention may be realized by providing a plasma display panel including a first substrate, a second substrate opposite the first substrate, at least one discharge space defined between the first and second substrates, a first electrode structure disposed between the first and second substrates and extending in a first direction, a barrier rib structure disposed between the first and second substrates, the barrier rib structure surrounding the discharge space, a second electrode structure disposed between the first and second substrates, surrounding the discharge space, and extending in a second direction, the second direction crossing the first direction, and a third electrode structure disposed between the first and second substrates, surrounding the discharge space, and extending in the second direction.

The second electrode structure may include two second electrode portions each of which surrounds a side of the discharge space, and the third electrode structure may include two third electrode portions each of which surrounds a side of the discharge space. Each of the two second electrode portions may include at least one arc-shaped section. Each of the two second electrode portions may include a plurality of arc-shaped sections, and neighboring arc-shaped sections may be directly connected to each other through ends thereof. Each of the two second electrode portions may include a plurality of arc-shaped sections, and neighboring arc-shaped sections may be connected to each other through a connecting member that extends in the second direction. Each of the two third electrode portions may include at least one arc-shaped section. The second electrode structure and the third electrode structure may be spaced apart in a third direction, the third direction being substantially normal to the first and second directions.

The plasma display panel may further include a phosphor layer disposed in the discharge space. The plasma display panel may be configured to emit visible light through the second substrate, the discharge space may have a first end adjacent to the first substrate and a second end adjacent to the second substrate, the first electrode structure may be disposed adjacent to the first end, and the phosphor layer may be a transmissive phosphor that covers the second end of the discharge space. The discharge space may have a first end adjacent to the first substrate and a second end adjacent to the second substrate, and the phosphor layer may cover the first end and the second end of the discharge space. The plasma display panel may be configured to emit visible light through the second substrate, the phosphor layer covering the first end of the discharge space may be a reflective phosphor, and the phosphor layer covering the second end of the discharge space may be a transmissive phosphor.

The second electrode structure and the third electrode structure may each be made of a material that is opaque to visible light. The second electrode structure and the third electrode structure may be embedded in a dielectric layer, a first surface of the dielectric layer may be disposed against the first substrate and a second surface of the dielectric layer may be disposed against the second substrate. The plasma display panel may further include a protective layer disposed on the dielectric layer along an inner surface of the discharge space.

The first electrode structure may include a discharge section that surrounds the discharge space. The discharge section may have a ring shape. The first electrode structure, the second electrode structure and the third electrode structure may be embedded in a dielectric layer, a first surface of the dielectric layer may be disposed against the first substrate and a second surface of the dielectric layer may be disposed against the second substrate.

At least one of the above and other features and advantages of the present invention may also be realized by providing a plasma display panel including a discharge space defined between first and second substrates, an address electrode proximate to the discharge space, and at least one display electrode surrounding the discharge space. The plasma display panel may further include another display electrode surrounding the discharge space, wherein the two display electrodes may each include sections having a shape corresponding to a shape of the discharge space, the two display electrodes being substantially equidistant from the discharge space. The address electrode may include a section that surrounds the discharge space.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a partial exploded perspective view of an exemplary PDP according to a first embodiment of the present invention, as well as a partial enlarged view thereof;

FIG. 2 illustrates a partial top plan view of the PDP of FIG. 1, taken along line II-II;

FIG. 3 illustrates an enlarged partial cross-sectional view of the assembled PDP of FIGS. 1 and 2, taken along line III-III of FIG. 2;

FIG. 4 illustrates an enlarged partial cross-sectional view of the assembled PDP of FIGS. 1 and 2, taken along line IV-IV of FIG. 2;

FIG. 5 illustrates a schematic of electrode structures of the PDP of FIG. 1;

FIG. 6 illustrates a schematic view of exemplary electrode structures according to a second embodiment of the present invention;

FIG. 7 illustrates a schematic view of exemplary electrode structures according to a third embodiment of the present invention;

FIG. 8 illustrates an enlarged partial cross-sectional view of an exemplary PDP according to a fourth embodiment of the present invention; and

FIG. 9 illustrates an enlarged partial cross-sectional view of an exemplary PDP according to a fifth embodiment of the present invention.

### DETAILED DESCRIPTION OF THE INVENTION

Korean Patent Application No. 10-2005-0066678, filed on Jul. 22, 2005, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. It will also be understood that the term “phosphor” is intended to generally refer to a material that can generate visible light upon excitation by ultraviolet light that impinges thereon, and is not intended be limited to materials the undergo light emission through any particular mechanism or over any particular time frame. Like reference numerals refer to like elements throughout.

PDPs according to embodiments of the present invention may include electrode structures that surround a discharge space, which may provide a larger effective aperture ratio and provide enhanced visible light emission.

Each electrode structure may include a pair of electrode portions that are disposed apart from each other with the discharge space interposed therebetween, thereby enabling an increased size of the discharge space, which may stabilize discharge and enhance luminance and luminous efficiency. Luminance and luminous efficiency may be enhanced even in a high-definition display having a discharge cell of a limited area.

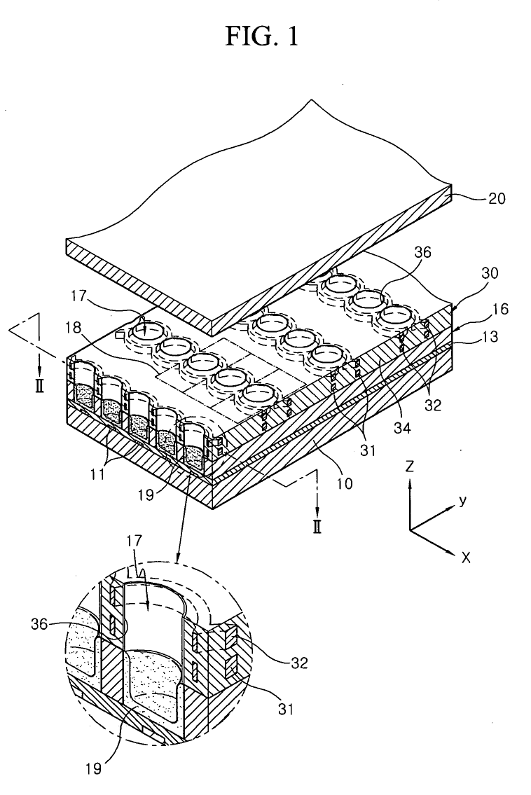

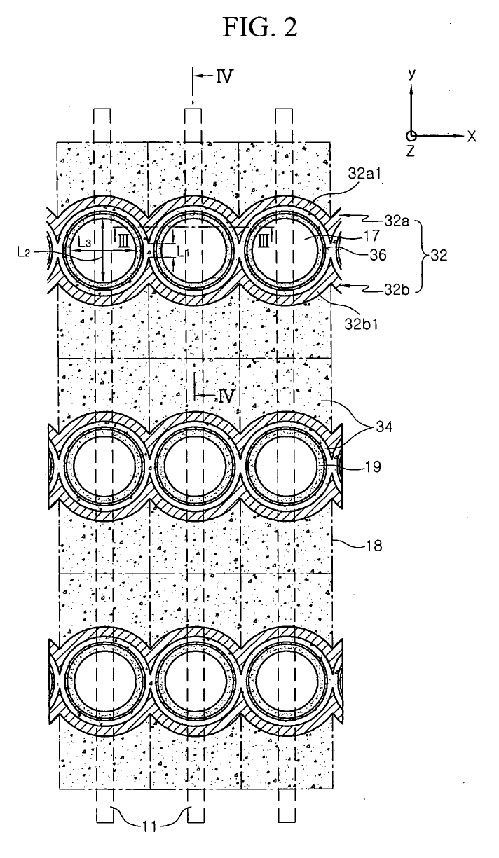

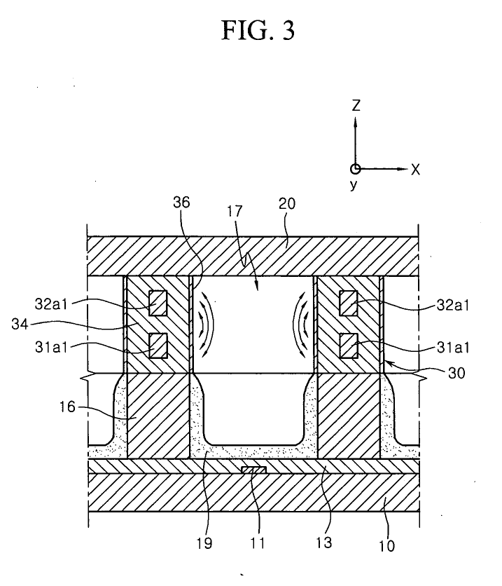

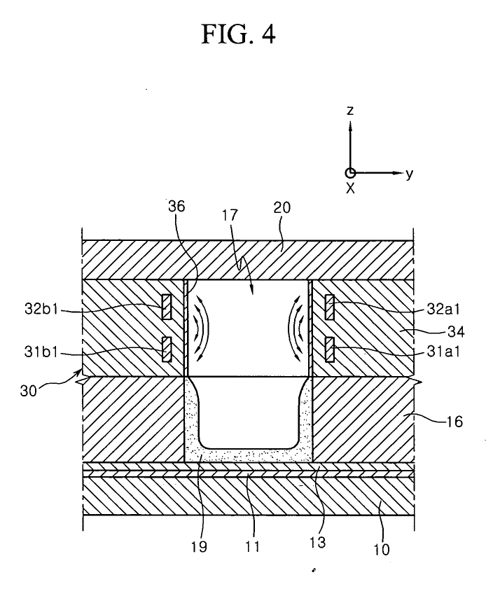

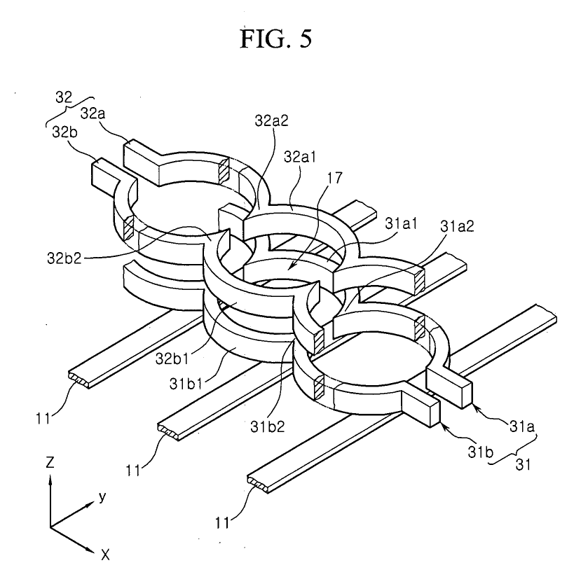

FIG. 1 illustrates a partial exploded perspective view of an exemplary PDP according to a first embodiment of the present invention, as well as a partial enlarged view thereof, FIG. 2 illustrates a partial top plan view of the PDP of FIG. 1, taken along line II-II, FIG. 3 illustrates an enlarged partial cross-sectional View of the assembled PDP of FIGS. 1 and 2, taken along line III-III of FIG. 2, FIG. 4 illustrates an enlarged partial cross-sectional view of the assembled PDP of FIGS. 1 and 2, taken along line IV-IV of FIG. 2, and FIG. 5 illustrates a schematic of electrode structures of the PDP of FIG. 1.

Referring to FIGS. 1-5, the exemplary PDP according to the first exemplary embodiment of the present invention may include a first substrate 10, e.g., a rear substrate, and a second substrate 20, e.g., a front substrate. The first substrate 10 and the second substrate 20 may be arranged opposite to one another and may be spaced apart by a predetermined distance in a first direction, e.g., the z-axis direction. A plurality of discharge spaces 17 may be defined between the first substrate 10 and the second substrate 20. The discharge spaces 17 may be cylindrical, i.e., may have a circular cross-section in the x-y plane, such that a distance from an inner circumference of the discharge space 17 to the center of the discharge space 17 is substantially uniform. The discharge spaces 17 may be defined by a barrier rib structure 16, which may be disposed between the first substrate 10 and the second substrate 20 and may surround each discharge space 17. The barrier rib structure 16 may be formed on the first substrate 10. A discharge gas may fill the discharge spaces 17, e.g., a mixed gas including neon (Ne) and xenon (Xe). UV light, e.g., vacuum ultraviolet light, may be generated by a plasma discharge in the discharge gas.

Phosphor layers 19 may be provided in the discharge spaces 17 and, during operation, the phosphor layers 19 may be excited or energized by UV light absorbed from the plasma discharge. The phosphor layers 19 may relax from the excited state to a lower energy state with an emission of visible light. The phosphor layer 19 may be disposed on an inner surface of the wall of the discharge space 17 defined by the barrier rib structure 16, and may be disposed on the end of the discharge space 17 defined by the rear substrate 10. The phosphor layer 19 may include a reflective phosphor, which absorbs UV light and reflects visible light toward the second substrate 20, i.e., towards the image-displaying side of the PDP.

The PDP may include first, second and third electrode structures 11, 31 and 32, respectively, disposed between the first substrate 10 and the second substrate 20. The first, second and third electrode structures 11, 31 and 32 may cross in regions corresponding to each discharge space 17.

The first electrode structure 11 may be disposed on the first substrate 10 and the barrier rib structure 16 may be disposed on the first electrode structure 11. The first electrode structure 11 may extend in a second direction, e.g., the y-axis direction. A plurality of the first electrode structures 11 may be disposed in parallel to each other and may be separated from each in a third direction, e.g., the x-axis direction, by a predetermined distance. First electrode structures 11 that are adjacent to one another in the third direction may correspond to discharge spaces 17 that are adjacent to one another in the third direction.

The first electrode structures 11 may be covered by a dielectric layer 13, which may reduce or eliminate damage to the first electrode structures 11 caused by positive ions or electrons colliding with the first electrode structures 11 during plasma discharge. The dielectric layer 13 may be formed of a dielectric material, such that wall charges can accumulate on the dielectric layer 13 during operation of the PDP. The phosphor layers 19 may be disposed on the surface of the dielectric layer 13, as well as on the sides of the barrier rib structure 16 as described above.

The second and third electrode structures 31 and 32 may extend in the third direction crossing the second direction, e.g., extend in the x-axis direction, so as to cross the first electrode structures 11. The second and third electrode structures 31 and 32 may be disposed between the first electrode structures 11 and the second substrate 20 in the first direction that is substantially normal to first and second substrates 10 and 20, e.g., the z-axis direction. The first, second and third electrode structures 11, 31 and 32 may be separated from one another in the first direction. The second and third electrode structures 31 and 32 may be provided as part of a separate electrode layer 30. Additional details of the second and third electrode structures 31 and 32 will be described below.

During operation of the PDP, the first electrode structure 11 may serve as an address electrode structure, the second electrode structure 31 may serve as a scan electrode structure and the third electrode structure 32 may serve as a sustain electrode structure. Each discharge space 17 may be addressed by an address pulse that is applied to the first electrode structure 11 and a scan pulse that is applied to the second electrode structure 31. After the discharge space 17 is addressed, a sustain pulse may be alternately applied to the second electrode structure 31 and the third electrode structure 32 so as to generate a sustain discharge in the selected discharge space 17, thereby producing an image.

Where the first electrode structure 11 serves as the address electrode structure and second electrode structure 31 serves as the scan electrode structure, the second electrode structure 31 may be positioned towards the first substrate 10 side of the electrode layer 30, between the third electrode structure 32 and the first electrode structure 11. Accordingly, the address electrode structure and the scan electrode structure may be separated by a relatively short discharge gap, which may allow the address discharge to be performed using a relatively low voltage.

Moreover, where the address electrode structures are disposed at the first substrate 10 side of the discharge space 17, the address electrode structures may be made of an opaque material such as metal, which has excellent electrical conductivity, because visible light does not need to be transmitted through the first substrate 10.

Further details of the second and third electrode structures 31 and 32 will now be described. The second electrode structures 31 may each include two second electrode portions, e.g., second electrode portions 31a and 31b. Similarly, the third electrode structures 32 may each include two third electrode portions, e.g., third electrode portions 32a and 32b. Each of the two second electrode portions 31a and 31b, and each of the two third electrode portions 32a and 32b, may extend in the third direction, e.g., the x-axis direction. The second electrode structures 31 and the third electrode structures 32 may have substantially symmetrical shapes, although such symmetry is not essential. That is, for example, the second electrode portion 31a may be substantially symmetrical to the second electrode portion 31b, and the second electrode portion 31a may have substantially the same shape as the third electrode portion 32a.

The second electrode portions 31a and 31b may be disposed apart from each other in the second direction, e.g., in the y-axis direction, with one or more discharge spaces 17 interposed therebetween. That is, the second electrode portion 31a and the second electrode portion 31b may be arranged opposite to each other, along two sides of the discharge space 17, such that, in the y-axis direction, the structure is arranged in the order of second electrode portion 31a, discharge space 17, and second electrode portion 31b. The second electrode portions 31a and 31b may surround the two sides of the discharge space 17. Where a plurality of discharge spaces 17 is disposed between two second electrode portions 31a and 31b, the plurality of discharge spaces 17 may form a series of discharge spaces 17 that also extends in the third direction, with the second electrode portion 31a along one side of the series and the second electrode portion 31b along an opposite side of the series.

The third electrode structures 32 may each include two third electrode portions, e.g., third electrode portions 32a and 32b. Similar to the second electrode structures 31 described above, the third electrode portion 32a and the third electrode portion 32b may be disposed apart from each other in the second direction, e.g., the y-axis direction, with one or more discharge spaces 17 interposed therebetween. That is, the third electrode portion 32a and the third electrode portion 32b may be arranged opposite to each other along two sides of the discharge space 17. The third electrode portion 32a and the third electrode portion 32b may surround the two sides of the discharge space 17. Each third electrode portion 32a and 32b may extend in the third direction and, where a plurality of discharge spaces 17 is disposed between the two third electrode portions 32a and 32b, the plurality of discharge spaces 17 may form a series of discharge spaces 17 that also extends in the third direction, between the two third electrode portions 32a and 32b.

Each second electrode structure 31 may have a corresponding third electrode structure 32, which together correspond to a given discharge space 17, the second electrode structure 31 and the third electrode structure 32 being disposed apart from each other in the first direction, e.g., the z-axis direction.

During operation of the PDP, a same voltage signal may be applied to the second electrode portion 31a and the second electrode portion 31b. For example, a voltage signal that is independently applied to the second electrode portion 31a may be equal to a voltage signal that is applied to the second electrode portion 31b. In another implementation, the second electrode portion 31a and the second electrode portion 31b may share a common electrode terminal (not shown), such that a same voltage signal is applied to both the second electrode portion 31a and the second electrode portion 31b.

Similarly, a same voltage signal may be applied to the third electrode portion 32a and the third electrode portion 32b, e.g., a voltage signal that is independently applied to the third electrode portion 32a may be equal to a voltage signal that is applied to the third electrode portion 32b, the third electrode portion 32a and the third electrode portion 32b may share a common electrode terminal, etc.

In this way, because the second electrode structure 31 and the third electrode structure 32 may be disposed in a symmetrical structure in the first direction, e.g., the z-axis direction, a sustain discharge generated between the second electrode structure 31 and the third electrode structure 32 may occur in the first direction. Therefore, a sustain discharge that is generated along an edge of the discharge space 17 between the second electrode structure 31 and the third electrode structure 32 may be concentrated in the center of the discharge space 17, thereby improving luminous efficiency. Furthermore, even if a discharge is performed for a long time, ions that are generated by the discharge may not be driven to collide with the phosphor layer 19 by the electric field. Therefore, damage to the phosphor layer 19 by ion sputtering may be reduced or prevented.

Because each of the second electrode structure 31 and the third electrode structure 32 may be arranged as a structure surrounding the discharge space 17, the sustain discharge may be uniformly formed in an entire inner circumference of the discharge space 17. In order to more uniformly diffuse the sustain discharge, the second electrode structure 31 and the third electrode structure 32 may be formed to a shape corresponding to that of the discharge space 17, so as to surround the discharge space 17 while being spaced apart from the walls of the discharge space 17 by a uniform distance. That is, where the discharge space is cylindrical, i.e., having a circular cross-section, each of the second electrode structure 31 and the third electrode structure 32 may be formed to closely follow the circular shape of the discharge space 17.

Each of the second electrode portions 31a and 31b may include an arc-shaped section that corresponds to the discharge space 17. That is, the second electrode portion 31a may include an arc-shaped section 31a1 and the second electrode portion 31b may include an arc-shaped section 31b1. The arc-shaped sections 31a1 and 31b1 may be arranged opposite to each other in a mirror image orientation, with the discharge space 17 interposed therebetween, so as to surround the discharge space 17. Where a plurality of discharge spaces 17 is disposed between the electrode portions 31a and 31b, the electrode portions 31a and 31b may include a plurality of arc-shaped sections 31a1 and 31b1, so as to surround each of the discharge spaces 17.

Arc-shaped sections 31a1 that are adjacent to one another may be directly connected to each other through ends 31a2 of the arc-shaped sections 31a1. That is, the electrode portion 31a may include, in series, an arc-shaped section 31a1 having an end 31a2 that is coupled to an end 31a2 of an adjacent arc-shaped section 31a1.

Each of the other electrode portions 31b, 32a and 32b may be similarly constructed so as to have a series of arc-shaped sections, joined at the ends, that extends in the direction of the electrode portion, e.g., in the x-axis direction. That is, the other second electrode portion 31b and each of the third electrode portions 32a and 32b may include arc-shaped sections 31b1, 32a1 and 32b1, respectively. The arc-shaped sections 31b1 may be arranged opposite to the arc-shaped sections 31a1 with the discharge space 17 disposed therebetween, and the arc-shaped sections 32a1 and 32b1 may be arranged opposite to each other with the discharge space 17 interposed therebetween, so as to surround a section of the discharge space 17. Neighboring arc-shaped sections 31b1, 32a1 and 32b1 in the third direction, e.g., the x-axis direction, may be directly connected to each other through ends 31b2, 32a2 and 32b2, respectively.

Referring to FIG. 2, the second electrode portion 31a and the second electrode portion 31b may be separated by a distance L₁ (as determined in the second direction, e.g., the y-axis direction), and the third electrode portion 32a and the third electrode portion 32b may be similarly separated by the distance L₁, where L₁ is determined at tips of the arc-shaped sections. A distance L₂ in the second direction and a distance L₃ in the third direction of the discharge space 17 may be increased in the discharge cell 18 having a predetermined size, such that an area of the discharge space 17 that is surrounded by the electrode structures 31 and 32 may be increased (see FIG. 2).

The above-described configurations of the second electrode structures 31 and the third electrode structures 32 may allow the discharge space 17 to be increased to a maximum size in a discharge cell 18 having a fixed area in the x-y plane. Accordingly, a stable discharge may be achieved and an amount of emitted VUV light may be increased.

Furthermore, an area of the phosphor layer 19 may be increased in a high-definition display in which an area of the discharge cell 18 is limited. As the area of the phosphor layer 19 increases, the emission of visible light may also be increased, thereby improving luminous efficiency.

Moreover, because the second electrode structures 31 and the third electrode structures 32 may be disposed around the sides of the discharge space 17, rather than being disposed in front of it, visible light emitted toward the second substrate 20 is not blocked by the electrodes. This may not only enable enhanced luminous efficiency, it may allow a broader range of materials to be used for the electrode structures. For example, the second electrode structures 31 and the third electrode structures 32 may be formed of an opaque material such as a metal having excellent electrical conductivity.

The second electrode structures 31 and the third electrode structures 32 may be covered with a dielectric layer 34. The second electrode structures 31 and the third electrode structures 32 may form an insulation structure, wherein a separate electrode layer 30 includes the second electrode structures 31, the third electrode structures 32 and the dielectric layer 34 in which they are embedded. The dielectric layer 34 may function to insulate the second electrode structures 31 and the third electrode structures 32 from each other, and may also accumulate wall charges during plasma discharge. That section of the discharge space 17 that is defined by the dielectric layer 34 may have a shape corresponding to that defined by the barrier rib structure 16, e.g., a cylindrical shape. The dielectric layer 34 and the barrier rib structure 16 may together define the discharge space 17, as illustrated in, e.g., FIG. 3.

A protective layer 36 may be formed on an inner surface of the dielectric layer 34, i.e., on a section of the dielectric layer 34 that is exposed to the plasma discharge. The protective layer 36 may function to protect the dielectric layer 34 and may emit secondary electrons during plasma discharge.

As the second electrode structures 31 and the third electrode structures 32 may be disposed along sides of the discharge space 17, rather than across ends of the discharge space 17 on the first substrate 10 or the second substrate 20, the protective layer 36 that is coated on the dielectric layer 34 for covering the second electrode structures 31 and the third electrode structures 32 may be made of a material that is non-transparent. Therefore, the material for the protective layer 36 may be selected to have a high secondary electron emission coefficient value, and need not be selected based on its ability to transmit visible light. For example, the protective layer 36 may be made of, e.g., non-transparent MgO. Non-transparent MgO may have a much higher secondary electron emission coefficient value than transparent MgO, and the use of non-transparent MgO may enable a lower discharge firing voltage.

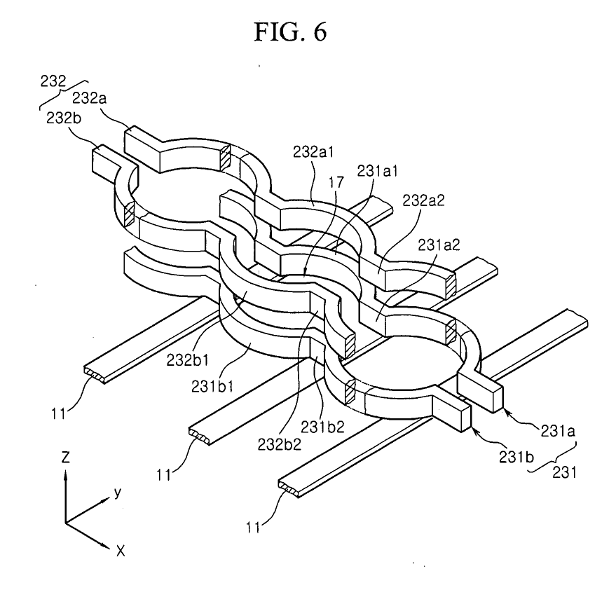

Additional embodiments of the present invention will now be described with reference to FIGS. 6-9. The following description will focus on elements that are different from those described above in connection with the first embodiment and, in order to avoid repetition, a detailed explanation of the other features will not be repeated.

FIG. 6 illustrates a schematic view of exemplary electrode structures according to a second embodiment of the present invention. Referring to FIG. 6, a second electrode structure 231 may include two second electrode portions 231a and 231b. Each of the second electrode portions 231a and 231b may include arc-shaped sections 231a1 and 231b1, respectively. Neighboring arc-shaped sections 231a1 in the third direction, e.g., the x-axis direction, may be connected to each other through connecting members 231a2. Similarly, neighboring arc-shaped sections 231b1 in the third direction may be connected to each other through connecting members 231b2. A third electrode structure 232 may include two third electrode portions 232a and 232b, which may include, respectively, arc-shaped sections 232a1 and 232b1 having neighboring arc-shaped sections 232a1 and 232b1 connected by connecting members 232a2 and 232b2. This may allow the discharge space 17 to be increased, thereby enabling a stable discharge and allowing an increased area of the phosphor layer, thus enhancing luminous efficiency.

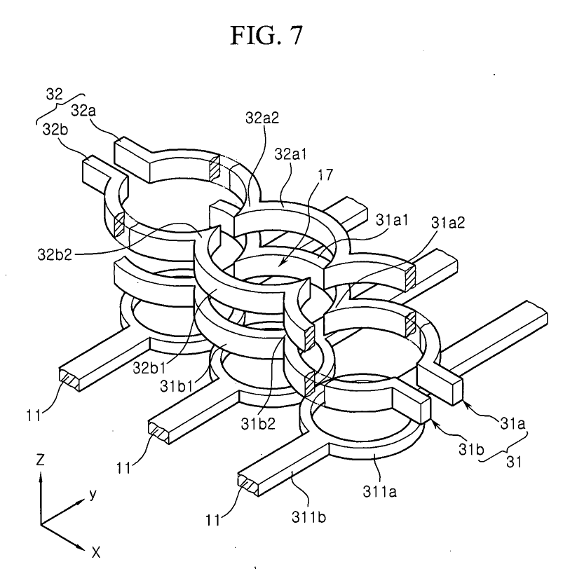

FIG. 7 illustrates a schematic view of exemplary electrode structures according to a third embodiment of the present invention. Referring to FIG. 7, a first electrode structure 311 may surround each discharge space 17. The first electrode structure 311 may include a discharge section 311a corresponding to each discharge space 17 and a connecting member 311b for connecting a discharge section 311a to a neighboring discharge section 311a that is adjacent in the second direction, e.g., in the y-axis direction. The discharge section 311a may have, e.g., a ring shape that surrounds the discharge space 17. The first electrode structure 311 may be employed as an address electrode structure, such that the discharge section 311a operates to generate an address discharge along with the second electrode structure 32, which may be employed as a scan electrode structure. The connecting member 311b may electrically connect the discharge sections 311a that are disposed to correspond to each discharge space 17 in the second direction.

The first electrode structure 311, the second electrode structure 31 and the third electrode structure 32 may form a separate electrode layer (not shown) and may be provided between the second substrate 20 and the barrier rib structure 16. That is, because the first electrode structure 311 may surround the discharge space 17, visible light that is emitted toward the second substrate 20 may not be blocked by the first electrode structure 311. Furthermore, because a discharge distance between the first electrode structure 311 and the second electrode structure 31 may be short, address discharge may be easily achieved.

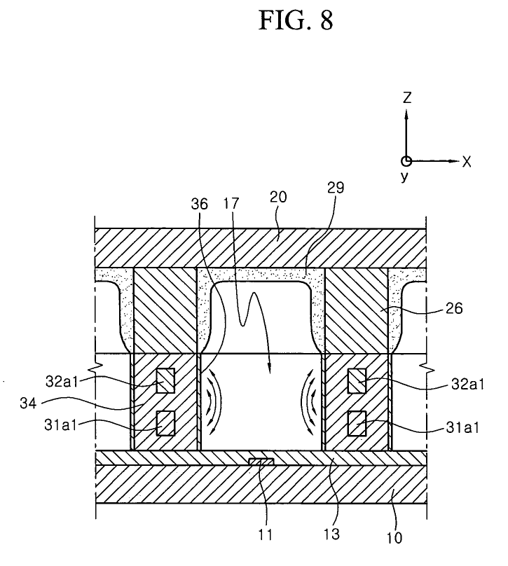

FIG. 8 illustrates an enlarged partial cross-sectional view of an exemplary PDP according to a fourth embodiment of the present invention. Referring to FIG. 8, the PDP may include a phosphor layer 29 disposed on front substrate 20. A barrier rib structure 26 may be disposed on the second substrate 20, and the phosphor layer 29 may be disposed within the discharge space 17 that is partitioned by the barrier rib structure 26. The phosphor layer 29 may be made of a transmissive phosphor, such that visible light that is emitted from the discharge space 17 may be transmitted to the second substrate 20.

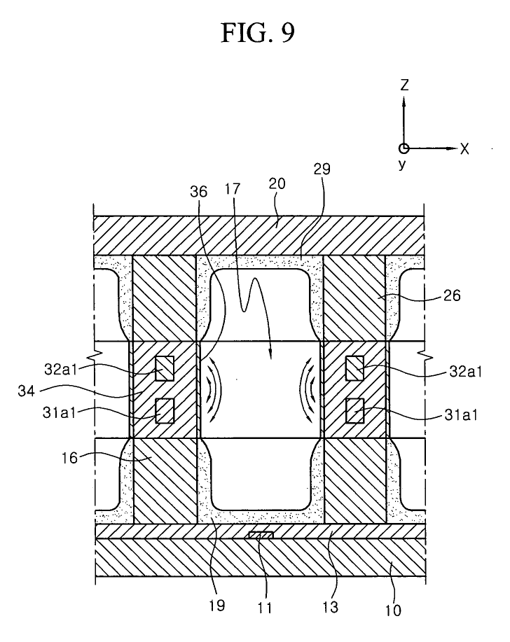

FIG. 9 illustrates an enlarged partial cross-sectional view of an exemplary PDP according to a fifth embodiment of the present invention. Referring to FIG. 9, the PDP may include both phosphor layers 19 and 29. The phosphor layer 19 may be provided on the first substrate 10 and the phosphor layer 29 may be provided on the second substrate 20. The first substrate 10 may serve as the rear substrate and the phosphor layer 19 may be implemented as a reflective phosphor, and the second substrate 20 may serve as the front substrate, through which a visible image is displayed, and the phosphor layer 29 may be implemented as a transmissive phosphor. Thus, the phosphor layers 19 and 29 may be formed on both the first substrate 10 side of the discharge space 17, as well as on the second substrate 20 side of the discharge space 17, which may enhance luminous efficiency.

Exemplary embodiments of the present invention have been disclosed herein, and although specific terms are employed, they are used and are to be interpreted in a generic and descriptive sense only and not for purpose of limitation. Thus, it will be understood by those of ordinary skill in the art that various changes in form and details may be made to the disclosed embodiments.

For example, while embodiments described above may employ the first electrode structures as address electrode structures, employ the second electrode structures as scan electrode structures and employ the third electrode structures as sustain electrode structures, it will be appreciated that the first electrode structures, the second electrode structures and the third electrode structures may perform different functions depending on the voltage signals applied to them.

Further, in the above-described embodiments the shape of the discharge space is not limited to a shape having a circular cross-section, and the discharge space may have any of a number of suitable shapes including, e.g., oval, rectangular, hexagonal, octagonal, etc. Similarly, the shape of the first electrode structure and the second electrode structure is not limited to having arc-shaped sections and may have oval sections, etc., and may have sections that form part of a polygon, e.g., a rectangle, hexagon, octagon, etc., corresponding to the shape of the discharge space. Also, a discharge section of the first electrode structure may be formed in various shapes corresponding to the shape of the discharge space.

Additionally, the barrier rib structure may be disposed on the first substrate and/or on the second substrate, and may be separately or integrally formed on the substrates. Moreover, the phosphor layer may be formed on the first substrate side of the discharge space and/or on the second substrate side of the discharge space, as well as on the sides thereof.

Furthermore, the first electrode structures, the second electrode structures and the third electrode structures may be formed as a separate electrode layer, the first electrode structures may be formed on the first and/or the second substrates, the second and third electrode structures may be formed as a separate electrode layer, etc. Additionally, the second electrode structures and the third electrode structures may be integrally formed with the barrier rib structure, i.e., the sidewalls of the discharge spaces may be defined by a single layer disposed between the first and second substrates, without the need for a separate barrier rib layer, the single layer including the second and third electrode structures.

Accordingly, it will be understood that embodiments of the present invention may be used alone or in combination, and changes in form and details may be made without departing from the spirit and scope of the present invention as set forth in the following claims.

What is claimed is:

1. A plasma display panel, comprising:
a first substrate;
a second substrate opposite the first substrate;
at least one discharge space defined between the first and second substrates;
a first electrode structure disposed between the first and second substrates and extending in a first direction;
a barrier rib structure disposed between the first and second substrates, the barrier rib structure surrounding the discharge space;
a second electrode structure disposed between the first and second substrates, surrounding the discharge space, and extending in a second direction, the second direction crossing the first direction; and
a third electrode structure disposed between the first and second substrates, surrounding the discharge space, and extending in the second direction.

2. The plasma display panel as claimed in claim 1, wherein the second electrode structure includes two second electrode portions each of which surrounds a side of the discharge space, and
the third electrode structure includes two third electrode portions each of which surrounds a side of the discharge space.

3. The plasma display panel as claimed in claim 2, wherein each of the two second electrode portions includes at least one arc-shaped section.

4. The plasma display panel as claimed in claim 3, wherein each of the two second electrode portions includes a plurality of arc-shaped sections, and
neighboring arc-shaped sections are directly connected to each other through ends thereof.

5. The plasma display panel as claimed in claim 3, wherein each of the two second electrode portions includes a plurality of arc-shaped sections, and
neighboring arc-shaped sections are connected to each other through a connecting member that extends in the second direction.

6. The plasma display panel as claimed in claim 3, wherein each of the two third electrode portions includes at least one arc-shaped section.

7. The plasma display panel as claimed in claim 1, wherein the second electrode structure and the third electrode structure are spaced apart in a third direction, the third direction being substantially normal to the first and second directions.

8. The plasma display panel as claimed in claim 1, further comprising a phosphor layer disposed in the discharge space.

9. The plasma display panel as claimed in claim 8, wherein the plasma display panel is configured to emit visible light through the second substrate,
the discharge space has a first end adjacent to the first substrate and a second end adjacent to the second substrate,
the first electrode structure is disposed adjacent to the first end, and
the phosphor layer is a transmissive phosphor that covers the second end of the discharge space.

10. The plasma display panel as claimed in claim 8, wherein the discharge space has a first end adjacent to the first substrate and a second end adjacent to the second substrate, and
the phosphor layer covers the first end and the second end of the discharge space.

11. The plasma display panel as claimed in claim 10, wherein the plasma display panel is configured to emit visible light through the second substrate,
the phosphor layer covering the first end of the discharge space is a reflective phosphor, and
the phosphor layer covering the second end of the discharge space is a transmissive phosphor.

12. The plasma display panel as claimed in claim 1, wherein the second electrode structure and the third electrode structure are each made of a material that is opaque to visible light.

13. The plasma display panel as claimed in claim 1, wherein the second electrode structure and the third electrode structure are embedded in a dielectric layer, a first surface of the dielectric layer being disposed against the first substrate and a second surface of the dielectric layer being disposed against the second substrate.

14. The plasma display panel as claimed in claim 13, further comprising a protective layer disposed on the dielectric layer along an inner surface of the discharge space.

15. The plasma display panel as claimed in claim 1, wherein the first electrode structure includes a discharge section that surrounds the discharge space.

16. The plasma display panel as claimed in claim 15, wherein the discharge section has a ring shape.

17. The plasma display panel as claimed in claim 15, wherein the first electrode structure, the second electrode structure and the third electrode structure are embedded in a dielectric layer, a first surface of the dielectric layer being disposed against the first substrate and a second surface of the dielectric layer being disposed against the second substrate.

18. A plasma display panel, comprising:
a discharge space defined between first and second substrates;
an address electrode proximate to the discharge space; and
at least one display electrode surrounding the discharge space.

19. The plasma display panel as claimed in claim 18, further comprising another display electrode surrounding the discharge space, wherein the two display electrodes each include sections having a shape corresponding to a shape of the discharge space, the two display electrodes being substantially equidistant from the discharge space.

20. The plasma display panel as claimed in claim 19, wherein the address electrode includes a section that surrounds the discharge space.
